(19) United States
(12) Patent Application Publication
(10) Pub. No.: US 2009/0290710 A1
(43) Pub. Date: Nov. 26, 2009

(54) UNLOCKING A PROTECTED PORTABLE STORAGE MEDIUM

(75) Inventors: Serhiy Tkachenko, Geldrop (NL); Victor Shcherbatyuk, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/721,478

(22) PCT Filed: Dec. 13, 2005
(86) PCT No.: PCT/IB2005/054215

§ 371 Date: Jun. 12, 2007

(30) Foreign Application Priority Data
Dec. 20, 2004 (EP) 04106707.5

(51) Int. Cl. H04N 7/167; H04L 9/00

(52) U.S. Cl. 380/203; 380/44

(57) ABSTRACT

The invention relates to a method, a media player (10) and a portable storage medium (8) for allowing removal of measures provided on said portable storage medium for disturbing content, as well as a method, a server (36) and a computer program product for allowing removal of measures for disturbing content on a portable storage medium. The media player obtains an identifier (DID) of the medium and a media player identifier (PID), generates an intermediate encryption key (I_K) based on at least these identifiers and sends the intermediate encryption key to the server (36). The server then encrypts an unlocking key (U K) by using at least the intermediate encryption key, and sends the encrypted unlocking key ([U_K]E) to the player, which in turn decrypts the unlocking key by using at least the intermediate encryption key, such that the measures for disturbing the perception of content provided on the medium can be removed.

### FIELD OF THE INVENTION

The present invention generally relates to the removal of protective measures for content provided in media streams and more particularly to a portable storage medium, a media player, a signal and a method of disturbing the perception of content provided in a first media stream.

### BACKGROUND OF THE INVENTION

In recent years, a number of standards for recording of multimedia data on portable storage mediums have been developed, for example, DVD (Digital Versatile Disc) and Blu-ray disc video. Different media streams are provided, which are multiplexed with each other into transport streams. A user can then also select the streams to be presented, for example, different audio language streams and different subtitle streams, depending on the relevant country.

When providing content on such a disc, it is advantageous to provide a limited version of the content, which limited version forms a subset of the whole content. This limited version can then be distributed freely for informing potential customers of some of the key features of the content. Once a customer purchases the content, he is given a full version of the content. This is normally done by providing separate discs, one with the limited version and the other with the full version. This is both a complex and expensive way of providing the content. It would therefore be beneficial if both the limited and the full version of the content could be provided together.

To solve this problem, it is possible to provide one disc with protective measures applied on it. An authorized user can get full access to the content after removal of the protective measures.

In order to protect content, it is nowadays customary to use complex and expensive content protection systems using safely stored secret keys in order to access content. It is relatively easy to bypass such systems.

Consequently, there is a problem of how to provide a simple way of allowing a user to remove the protective measures while at the same time safeguarding the interests of a content provider.

Document U.S. Pat. No. 5,754,649 describes a video disc for security and tracking data in the rental video media market. As described in this document, a unique disc player identity is provided on a separate magnetic track of a disc together with two versions of a movie identification number, one provided optically on the disc and the other on the separate magnetic track. This is done by a video rental store and here a user has to provide the disc player identity to the store. The disc player also includes a circuit which is arranged to read a video disc and compare the stored player identity with its own player identity as well as with the two movie identification numbers. The disc is only played if the numbers and identities match. In this way, it is possible for a video rental store to keep track of how often a video disc is rented and make sure that a rented video is not played on equipment other than the one intended.

In view of the prior art, it would therefore be advantageous to provide an improved way of controlling access to content on a portable storage medium and especially the limits of further spreading of accessed content.

### OBJECT AND SUMMARY OF THE INVENTION

It is therefore an object of the present invention to solve the above-mentioned problem by providing an improved way of controlling access to content on a portable storage medium.

According to a first aspect of the present invention, this object is at least partly achieved by a method of allowing removal of measures provided on a portable storage medium for disturbing the perception of content on the medium, the method comprising the steps of:

obtaining an identifier of the medium,

obtaining an identifier of a media player arranged to play media content provided on the medium,

generating an intermediate encryption key based at least on the medium identifier and the media player identifier, such that a request for removal of the disturbing measure can be made, the request comprising providing a content provider with at least the intermediate encryption key,

receiving an unlocking key, which has been encrypted on the basis of at least the intermediate encryption key, and

decrypting the unlocking key, using at least the intermediate encryption key, such that the measures for disturbing the perception of content provided on the medium can be removed.

According to a second aspect of the present invention, the object is also at least partly achieved by a media player for allowing removal of measures provided on a portable storage medium for disturbing the perception of content on the portable storage medium and having an identifier, the media player comprising:

a disturbing measure removal unit arranged to:
obtain an identifier of the medium,
obtain the media player identifier,
generate an intermediate encryption key based on at least the medium identifier and the media player identifier, such that a request for removal of the disturbing measure can be made, the request comprising providing a content provider with at least the intermediate encryption key,
receive an unlocking key, which has been encrypted on the basis of at least the intermediate encryption key, and
decrypt the unlocking key, using at least the intermediate encryption key, such that the measures for disturbing the perception of content provided on the medium can be removed.

According to a third aspect of the present invention, the object is also at least partly achieved by a portable storage medium to be used in a media player, the medium having stored thereon:

media content and measures provided for disturbing the perception of said content,

a medium identifier, and

a computer program code, which, when loaded in the media player, enables said media player to:
obtain the medium identifier,
obtain an identifier of the media player,
generate an intermediate encryption key based on at least the medium identifier and the media player identifier, such that a request for removal of the disturbing measure can be made, the request comprising providing a content provider with at least the intermediate encryption key, and
decrypt a received unlocking key, using at least the intermediate encryption key, such that the measures for disturbing the perception of content provided on the medium can be removed.

According to a fourth aspect of the present invention, the object is also at least partly achieved by a method of allowing removal of measures provided on a portable storage medium for disturbing the perception of content provided on the medium, the method comprising the steps of:

receiving an intermediate encryption key generated on the basis of at least an identifier of the medium and an identifier of a media player arranged for playing media content provided on the medium,

encrypting an unlocking key for removing measures provided on the medium for disturbing the perception of content thereon, using at least the intermediate encryption key, and

sending the encrypted unlocking key, such that the measures for disturbing the perception of content provided on the medium can be removed in the player in which the medium is loaded.

According to a fifth aspect of the present invention, the object is also at least partly achieved by a server for allowing removal of measures provided on a portable storage medium for disturbing the perception of content provided on the medium, the server being arranged to:

receive an intermediate encryption key generated on the basis of at least an identifier of the medium and an identifier of a media player arranged for playing media content provided on the medium,

encrypt an unlocking key for removing measures provided on the medium for disturbing the perception of content thereon, using at least the intermediate encryption key, and

send the encrypted unlocking key, such that the measures for disturbing the perception of content provided on the medium can be removed in the player in which the medium is loaded.

According to a sixth aspect of the present invention, the object is also at least partly achieved by a computer program product for allowing removal of measures provided on a portable storage medium for disturbing the perception of content provided on the medium and comprising a computer program code, which, when loaded in the server, causes said server to:

encrypt an unlocking key for removing measures provided on the medium for disturbing the perception of content thereon, using at least a received intermediate encryption key generated on the basis of at least an identifier of the medium and an identifier of a media player, and

at least order sending of the encrypted unlocking key, such that the measures for disturbing the perception of content provided on the medium can be removed in the player in which the medium is loaded.

The present invention allows removal of measures disturbing the perception of content in a simple manner and does not need complex and secret steps to be performed. At the same time, it is guaranteed that content is not spread further without the control of a content provider. Furthermore, the scheme is still safe because it is based on an identity of both the medium and the player. The invention is easy to implement because it does not require secrecy of certain information on the portable storage medium.

As defined in claim 2, a request is sent from the media player to the content provider regarding removal of a disturbing measure. This feature has the advantage that a user does not have to perform this manually and is thus a simpler way of obtaining an unlocking key for removing disturbing measures.

As defined in claim 3, the disturbing measure is removed by using the decrypted locking key. This feature has the advantage that a user does not have to manually enter the decrypted unlocking key for removing disturbing measures.

As defined in claim 4, the portable storage medium comprises a command structure that is set to select the presentation of a protection stream in relation to a user-selected stream, which setting is removed by using the decrypted unlocking key. This feature has the advantage of using an existing command structure for both the provision of a disturbing measure and its removal. In this way, the removal can be realized in a simple and cost-effective way.

As defined in claim 5, the portable storage medium comprises a transport stream including both a user-selected stream and a protection stream, which protection stream has user-selectable objects with associated actions that automatically provide disturbing measures, the links between objects and actions being removed by using the decrypted unlocking key. This feature has the advantage of providing an effective disturbing measure that is easily removed. Both the provision and removal of the disturbing measure is simple and cost-effective because of the use of an existing stream structure.

The basic idea of the present invention is to use both a portable storage medium identity and the identity of the player used for playing content on the portable storage medium in order to obtain an unlocking key used for unlocking the portable storage medium. This removes the protection in a simple way while at the same time safeguarding the interests of the content provider.

The above-mentioned and other aspects of the invention are apparent from and will be elucidated with reference to the embodiments described hereinafter.

### BRIEF DESCRIPTION OF THE DRAWINGS

The present invention will be further described with reference to the accompanying drawings, in which:

FIG. 1 schematically shows clips of media data together with a command structure provided for playing these clips,

FIG. 2 schematically shows the presentation of an interactive graphics stream on top of a video stream,

FIG. 3 schematically shows a portable storage medium comprising the clips together with software for providing the command structure shown in FIG. 1,

FIG. 4 is a block diagram of a media player arranged to provide the command structure of FIG. 1 as well as play the clips also provided in FIG. 1,

FIG. 5 schematically shows a media player communicating with a portable storage medium and a content,

FIG. 6 is a flow chart of a method according to the present invention, implemented in the player and allowing removal of measures that disturb the perception of content,

FIG. 7 is a flow chart of a method implemented in the server and allowing removal of measures that disturb the perception of content according to the present invention, and

FIG. 8 is a schematic view of a computer program product in the form of a CD ROM disc comprising a computer program code for performing the method in FIG. 7.

### DESCRIPTION OF EMBODIMENTS

The present invention generally relates to removal of measures that are provided for disturbing the perception of media content on a portable storage medium. A portable storage medium is normally an optical disc. However, other types of mediums are also possible for use in the present invention, such as, for instance, memory sticks. Before the details of removing the disturbing measures according to the present invention are further described, the general structure of the way in which information can be provided on such a storage medium and how it is used for controlling media streams will be described first

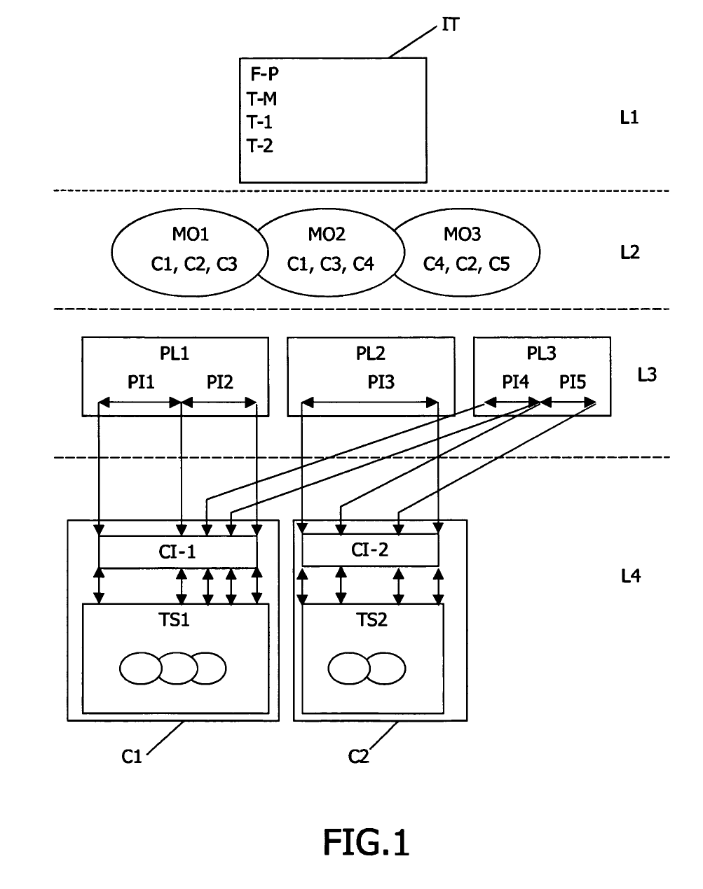

FIG. 1 is a schematic drawing of a media content command structure provided by a computer program code on a portable storage medium. The content command structure is operative when the computer program code is loaded in a memory and run on a suitable processor, which is normally provided in the control unit of a media player. The structure is grouped into different layers L1, L2 and L3. Another layer L4 provides media content which is controlled by the command structure. A first top layer L1 includes an Index table IT comprising a first playback item F-P, a top menu item T-M, a first title item T-1, and a second title item T-2. This layer L1 is adapted to communicate with a user interface via which a user can access the media content on the medium. This top layer L1 covers a second layer L2 comprising a number of command modules, also referred to as Movie Objects MO1, MO2, MO3. These movie objects MO1, MO2 and MO3 are activated by items in the index table IT in the top layer L1 on the basis of user inputs. A third layer L3 comprises a number of media stream control modules in the form of Play Lists PL1, PL2 and PL3 each having one or more play item control modules PI, which will hereinafter be denoted as play items. The play items PI point at data in a fourth layer L4, which data is provided in the form of clips C1 and C2 each comprising a transport stream TS1 and TS2 of multiplexed media streams together with corresponding overhead data in the form of clip information files CI-1 and CI-2.

A transport stream TS includes a video stream in the form of MPEG coded video packets, an audio stream in the form of Dolby AC-3 coded audio packets together with stream control packets, as well as an interactive graphics stream and a presentation graphics and text stream. An interactive graphics stream will be described hereinafter. A presentation graphics and text stream provides additional graphics and text. The presentation graphics and text stream is provided as two-dimensional run-length encoded raster images together with control information for placement of images, colors, etc. The streams are divided into access units or frames The streams are provided with presentation time stamps as well as source packet numbers, and a corresponding clip information file CI includes EP-tables with information pointing at the entry and exit points of a transport stream in order to allow switch-over between different transport streams. An EP-table is provided for some access units of a stream and with a small time interval between each EP-table. If a video stream is provided, the table always points at the first video packet of the access unit. If there is no video stream, the table points at the first audio packet of an access unit, and if there is no video or audio stream, there is no EP-table at all.

Document EP1 198 133, which is herein incorporated by reference, also describes how transport streams and clip information files can be set up and made to cooperate.

A play list PL comprises a number of play items PI, wherein a play item can point at an entry and exit location in a clip information file CI. The play list can then include several play items and, in this way, a number of transport stream sections can be made to be played after each other. FIG. 1, which is merely an example, shows that the first play list PL1 has a first play item PI1 pointing at a first section of the first clip C1 and a second play item PI2 pointing at a second section of the first clip C1. The second play list PL2 has a third play item PI3 pointing at the whole second clip C2, while the third play list PL3 has a fourth play item PI4 pointing at a section of the first clip C1 and a fifth item PI5 pointing at a section of the second clip C2.

Via the play list, it is further possible to select the playing of other streams that are related to a transport stream. One such stream is a text subtitle stream, which is provided as a separate transport stream that is synchronized with the main transport stream. This stream includes a number of packets with text information as well as other information such as definitions of box size, font type and size of characters. Such a file does not have a clip information file associated with it. This stream also has timing positions provided in the header of each access unit. Another such stream is a different angle of the same video content, i.e. video information shot by another camera. In the present context, the other angle is provided in a different transport stream with a separate clip information file. Here, only the coded video streams differ, but at least the number of other types of streams in the transport streams is the same and hence a play item can refer to two different video streams. An angle is one measure that can be used for disturbing the perception of content.

A user can select to play the media data provided in a clip via selections made in the index table IT. Once an item is selected in the table, this item calls upon a movie object MO, which in turn selects a play list PL. Via the play list, the actual content to be presented is selected. As mentioned above, a movie object MO is a set of commands executed by the player in which the medium is loaded, wherein one command can call upon a play list PL and order the playing of the content that this play list is pointing at. Another type of command points at another movie object. It is also possible for a movie object to point at an entry in the index table. These types of commands can then be made to jump unconditionally to another movie object, play list, entry in the index table, or resume operation after the actions performed via the index table, movie object and/or play list have been finished. It is further possible to make a jump or selection conditionally based on a comparison of different pieces of information with each other. The movie object also includes commands such as set stream, which is applicable to the different types of streams such as video, audio, presentation graphics and text as well as the interactive graphics stream. This command sets a certain type of stream to be played when a play list is being activated. It should also be realized that there is no one-to-one relationship between movie objects and entries in the index table. An item in the index table calls upon a movie object, but there might be movie objects that items in the index table do not directly call upon.

A stream allocation table, which is also called an STN table, is associated with each play item PI. The table includes settings that are allowable for a transport stream of a play item, i.e. which one of the different streams of a clip a user can select and what streams in a transport stream or in other transport streams are associated with each other. The streams set in the table are the streams that are allowed for a user to play.

Furthermore, a user-operating mask table associated with a play item is provided. This table has a number of flags, which define if a user is allowed to make changes in relation to certain streams, for example, if a user is allowed to change audio streams, presentation graphics and text streams, angle, or select buttons and activate buttons. The two latter flags are related to the interactive graphics stream, wherein buttons are provided. The relevance of these buttons will be described hereinafter.

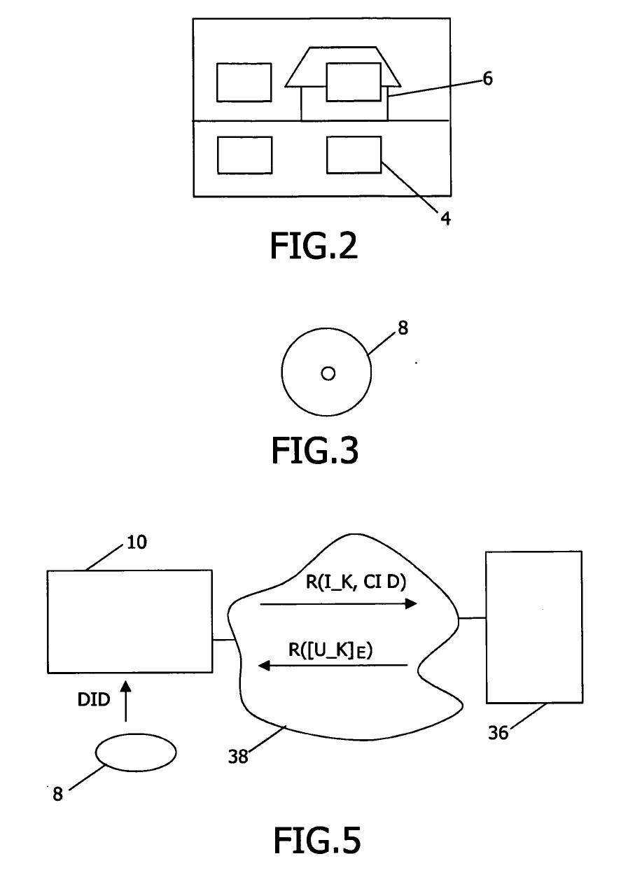

The interactive graphics stream is provided as an overlay screen which can be provided on top of a video stream displaying a group of graphical objects. These graphical objects are provided as two-dimensional run-length encoded raster images. The stream also comprises control information for placement of images, colors, etc. Some objects in the stream are buttons. In a certain overlay screen, a group of buttons can thus be provided, while a group can be limited to one button. Each button of each screen can be associated with a command script. For this reason, a button is an object embedded in the interface graphics stream that can be selected by a user. Such an overlay screen is shown in FIG. 2, which shows a number of buttons 4 provided on top of a video image provided through MPEG coding, which video image here shows a house 6. The overlay image can be set to be displayed at different time positions indicated by time stamps in headers of the first such packet in the access units.

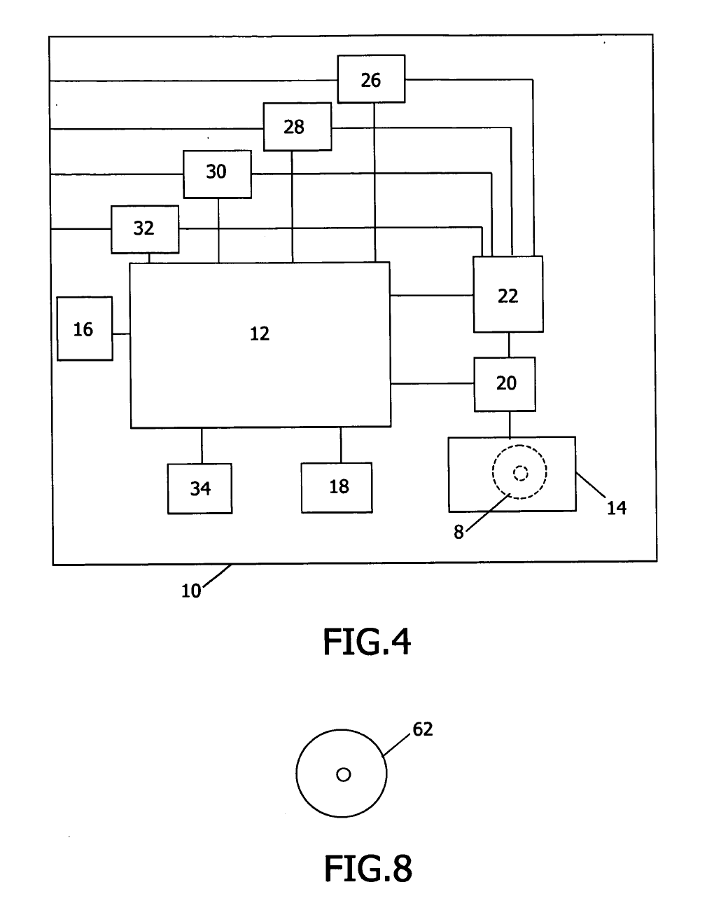

FIG. 3 shows a portable storage medium in the form of an optical disc 8 on which a computer program code enabling the provision of the command structure in layers L1, L2 and L3 of the system in FIG. 1 is stored together with the clips C1 and C2 in layer L4 of the same Figure. The command structure in layers L1 to L3 is then moved to a media player, an example of which is shown in a block diagram in FIG. 4.

The player 10 includes an optical disc drive 14 arranged to receive the disc 8. The device also includes a control unit 12 and a user interface 16 connected to the control unit 12. The disc drive 14 is connected to a reading unit 20 for reading information on the disc 8. The reading unit 20 is further connected to the control unit 12 and to a stream-separating unit 22, which is arranged to receive clips, remove clip information files and supply them to the control unit 12 and separate or demultiplex the media streams that are provided in transport streams into separate media streams. The stream-separating unit 22 is therefore connected to a video decoding unit 32 for decoding MPEG video signals, an audio decoding unit 30 for decoding audio, a graphics processing unit 28 for processing presentation graphics and text streams and to an interactive graphics processing unit 26 for processing interactive graphics streams. The control unit 12 is also connected to all of these units 32, 30, 28 and 26 for controlling them as well as to a status register 18, which stores current status information of the player 10, such as current angle, current audio and current play item A disturbing measure removal unit or encryption unit 34 is also provided in the player, which encryption unit is connected to the control unit 12.

When the disc 8 is loaded in the player 10 and the command structure is loaded in the control unit, a movie object, such as the second Movie Object MO2 in FIG. 1, is selected via user selection of an item in the index table IT. The user does so for selection of playing streams of a clip and here, as an example, the audio and video stream of the second clip C2, one of which is also called a first stream. This movie object includes a set stream command, which automatically sets a second stream to be played, which is a protection stream to be used for disturbing the perception of content associated with the selected item The movie object then selects a play list, such as the second play list PL2, and play items therein, such as the third play item PI3 that points at the second transport stream TS2. The protection stream is thus automatically selected in addition to the user-selected streams or instead of one of them. Then the user-operating mask table associated with the play item is set so that a user cannot influence the protection stream. This is done by setting the appropriate flag associated with the protection stream to disallow changes by the user. Subsequently, the play item PI3 in the second play list PL2 plays the second clip C2. Because of the set stream command, it is then ensured that the protection stream will be played when the play item starts playing the second transport stream TS2.

The protection stream may be another angle of video, which angle is video content coded with a lower quality. Once a certain piece of video is selected for playing, a change is then made to a different transport stream having the low-quality video. It may also be a different audio stream, such as a stream in a language that is different than the normal language or audio having an unintelligible sound. Another possible stream is the presentation graphics and text stream, for example for displaying warning messages, such as messages indicating that the content is protected, or one or more geometrical shapes such as a rectangle or a triangle, which can also be moved across the ordinary video content. Yet another protection stream is a text subtitle stream, wherein texts for subtitles are chosen to include characters that are most disturbing to a user. In this case, characters of a certain type can be used, such as the Webdings type with maximum font size. The subtitle can then also be set to move across the ordinary video content in order to obtain optimal protection.

The protective stream may also be an interactive graphics stream. This stream can be provided in such a way that it blocks or does not block the view. The buttons can thus be made to be transparent, semi-transparent or non-transparent. Furthermore, this stream can be provided in such a way that the buttons are provided very frequently in the stream and a command script is associated with each of at least one of the frequently recurring buttons. The button is associated with a set stream command which is further set in such a way that it is always automatically invoked by the button in question. This means that a command script that acts to disturb the perception of the content is invoked whenever the button in question appears in the stream. In this case, the command script can be set to change the stream regularly in such a way that, for instance, the video stream is always changed to the low-quality video stream. The command script can also be set to switch between different audio streams or provide different presentation graphics and text streams, text subtitle streams or interactive graphics streams. It is further possible to continuously change between different streams whenever such a button appears, for instance, constantly switching between different audio streams, perhaps combined with muting of the sound, or constantly switching between different angles of video. By setting the button-related items in the user-operating mask table of the play item, user influence on the buttons is disallowed. Through a setting made in the user-operating mask table associated with the command script, the user is stopped from being able to remove the automatic selection of the command script.

A protection stream can be set for a part of a clip together with a normal unblocked presentation for another part. One example of this can be seen in FIG. 1, in which the third play list PL3 includes a fourth play item PI4, which may be an item that is directed towards providing protection streams, together with a play item, the fifth play item PI5, which provides unrestricted viewing of content. In this way, it is possible for a user to get unlimited access to some parts of the content together with disturbed content in order to be able to perceive the content for deciding on a purchase or not. Thus, at least a part of a first user-selected media stream gets disturbed by a corresponding part of a second media stream.

Now that a disc with this type of protection stream provided on it has been studied by a user, the user might want to purchase the content. The present invention aims at providing a way for a user to remove the presentation of this protection stream while at the same time safeguarding the interests of the content provider and thus ensuring that the content is prevented from being used where it should not be used.

In order to do this, the user has to get information in one way or another, which can remove the protective measures provided on the disc.

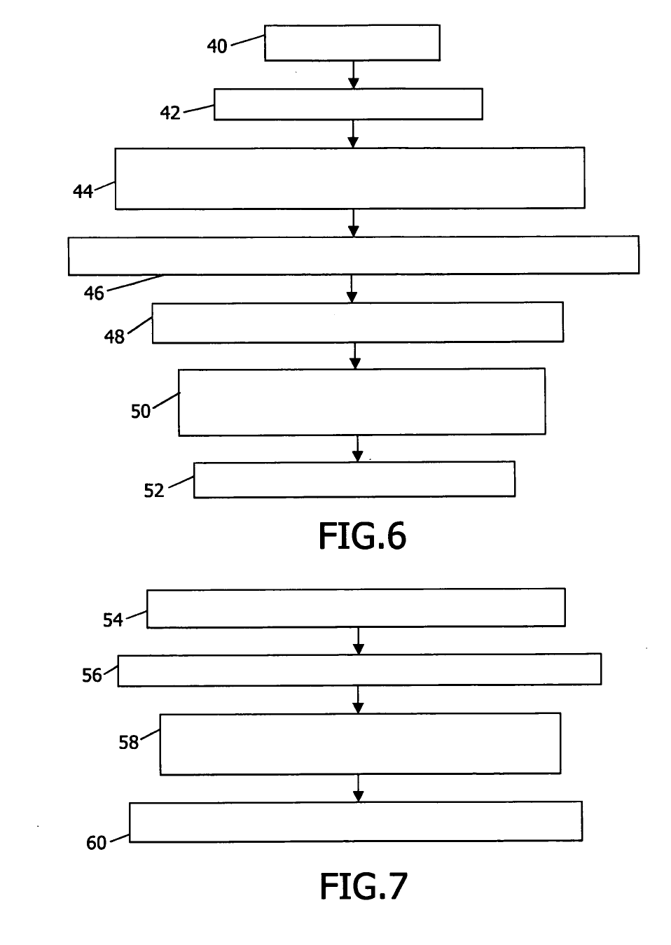

One way of doing this will now be explained with reference to FIGS. 1, 4, 5, 6 and 7. FIG. 5 is a schematic view of the player communicating with a server via a network and with the disc. FIG. 6 is a flow chart of a method of allowing removal of measures for disturbing the perception of content provided in the player, and FIG. 9 is a flow chart of a method of allowing removal of measures that disturb the perception of content, which method is provided in the server.

When the user has watched the protected content, he can decide to purchase it. He might then be presented with this offer via the command structure provided in FIG. 1. However, this offer might just as well be provided outside the actual command structure, but under the control of the control unit 12. An embodiment provided outside the command structure will be described hereinafter.

When the user decides to purchase the content on the disc 8, the control unit 12 orders the disc encoding unit 34 to initiate the unlocking process. The encryption unit 34 fetches a disc identity DID from the disc, step 40. The disc identity DID is a unique identifier associated with the disc 8. Subsequently, the encryption unit 34 obtains a unique player identity PID, step 42. The encryption unit 34 generates an intermediate encryption key I_K from at least these two identities, step 44. This intermediate encryption key I_K is generated by using a first encryption function, which can be implemented simply by performing a hash of the two values. The intermediate encryption key I_K is then stored together with the disc identity DID for later use. Subsequently, the control unit 12 connects the player 10 to the network 38, which is preferably the Internet, and sends a request R(I_K, CID) for removal of the disturbing measure comprising the intermediate key I_K and a content identifier CID identifying the content of the disc to a server 36 of the content provider, step 46. The content identifier CID may be the disc identifier DID or some other identifier identifying the content, but also the actual disc. In relation to sending this request, some information of an economic transactional nature is normally provided in order to ensure payment for the content.

The server 36 of the content provider has a database with information of discs having content and their keys for unlocking this content. The server 36 thus first receives the request R(I_K, CID) including the intermediate encryption key I_K and the content identifier CID, step 54. Based on the received information and especially on the content identifier CID, the server then fetches an unlocking key U_K associated with the disc 8, step 56, and continues and encrypts the key by using a second encryption function, which is an encryption function that uses at least the intermediate encryption key I_K, step 58. The encrypted unlocking key [U_K]_{E} is then sent to the player 10 in a response R([U_K]_{E}), step 60.

The player 10 subsequently receives the encrypted unlocking key [U_K]_{E}, step 48, which key is forwarded to the encryption unit 34 that continues and decrypts it by using a decrypting function and at least the intermediate encryption key I_K, step 50. This now decrypted unlocking key U_K is then used to unlock the disc, step 52. Note that it is impossible for another player to use the unlocking key, since it is protected by the intermediate encryption key I_K.

According to one embodiment of the present invention, the encrypting unit 34 stores the unlocking key in a register in the status register 18. The actual unlocking can then be done in the following way. Now that the unlocking key U_K is stored in a status register 18 and a user tries to play content that was formerly blocked, the called movie object performs a comparison of the status register setting with an internally provided correct unlocking key value. When the comparison indicates that no match is made, the set stream command is set to play the protection stream in the same manner as described above, whereas no set stream command is set when the comparison indicates that a match is made. In the case of an STN table setting, a movie object activates play items that have protection streams defined in their STN tables when no match is made, and play items where no such STN settings are made are activated when a match is made. The set stream command would then not appear in this unlocking sequence. The unlocking sequence can also be followed or preceded by a resetting of the user-operating mask table for allowing all changes to the content both for the protection stream and for the individual command scripts of an interactive graphics stream if this stream is a protection stream. If an unlocking operation is performed, the control unit can further be set to remove all settings made in relation to activation of command scripts in the protection stream or allow a user to remove them from this protection stream.

The different method steps performed in the player are also provided in Table I, shown below.

TABLE I

| | |
|---|---|
| 40 | OBTAIN DID |
| 42 | OBTAIN PID |
| 44 | GENERATE INTERMEDIATE ENCRYPTION KEY FROM AT |
| | LEAST DISC ID AND PLAYER ID |
| 46 | SEND INTERMEDIATE ENCRYPTION KEY TO CONTENT |
| | PROVIDER |
| 48 | RECEIVE ENCRYPTED UNLOCKING KEY |
| 50 | DECRYPT UNLOCKING KEY AT LEAST USING |
| | INTERMEDIATE ENCRYPTION KEY |
| 52 | UNLOCK DISC |

The different method steps performed in the server are also provided in Table II, shown below.

TABLE II

| | |
|---|---|
| 54 | RECEIVE INTERMEDIATE ENCRYPTION KEY |
| 56 | FETCH UNLOCKING KEY ASSOCIATED WITH DISC |
| 58 | ENCRYPT UNLOCKING KEY USING AT LEAST |
| | INTERMEDIATE ENCRYPTION KEY |
| 60 | SEND ENCRYPTED UNLOCKING KEY TO PLAYER |

The invention has the following advantages. It allows removal of measures disturbing the perception of content in a simple manner and does not need complex and secret steps to be performed. At the same time, it is guaranteed that content is not spread further without the control of the content provider. The scheme is safe because it is based on an identity of both the medium and the player. The invention is easy to implement because it does not require secrecy of certain information on the portable storage medium.

There are a number of variations that are possible in relation to the present invention. In the unlocking procedure outlined above, the disturbing measure removal unit was an encryption unit separate from the command structure provided on the disc. However, it is possible to provide this disturbing measure removal unit also in the command structure and then perhaps in a movie object. In this structure, it might not be possible to send the request to the server because the format of the disc does not allow this. In this case, the player may provide the user with the intermediate encryption key and he has to contact the server personally and send the information to this server, perhaps by using a normal PC or via a telephone conversation with a content provider operator. It should also be realized that the encrypted unlocking key might be received through the same channel and fed manually into the player by the user. Another variation is that removal of the protective measure is only possible when the device is connected to the server. In this way, it is possible for the content provider to constantly monitor and/or control access to the content for individual users. Another possible variation is that a correct match is stored by setting a flag, such that a movie object just looks at this flag so as to decide if the disc is to be unlocked or not. It is further possible that the status is remembered for a number of discs so that a user does not have to enter an unlocking key whenever a disc is loaded in the player. It is also possible to provide the locking for child protection of certain parts of the media and use the unlocking system for adult viewing.

The present invention may be used in circumstances other than those described. It can be used, for instance, within the framework of digital video broadcasting, in which additional protection streams would be transmitted together with video and audio streams. The invention may also be implemented in Video-On-Demand applications.

The control unit is preferably provided in the form of a processor with an associated program memory, which comprises a program code for fetching the command structure which can be stored for performing the method according to the invention.

The other parts of the player can be implemented in any suitable form including hardware, software, firmware or combinations of these. Especially the decoders and processing units may be provided in hardware.

The disturbing measure removal unit might be provided as a separate piece of hardware or as software. When it is software, it may be provided on the disc containing the media data and then also in the command structure. The server is also preferably provided in the form of a processor with a corresponding program memory comprising a computer program code for providing the method of allowing removal of measures that disturb the perception of content. This program code can also be provided on a disc, like a CD ROM disc 62, as shown in FIG. 8.

The elements and components of an embodiment of the invention may be physically, functionally and logically implemented in any suitable way. Indeed, the functionality may be implemented in a single unit, in a plurality of units or physically and functionally distributed between different units and processors.

Although the present invention has been described in connection with specific embodiments, it is not intended to be limited to the specific form set forth herein. Rather, the scope of the present invention is limited only by the accompanying claims. In the claims, use of the verb “comprise” and its conjugations does not exclude the presence of other elements or steps. Although individually listed, a plurality of means, elements or method steps may be implemented by e.g. a single unit or processor. Individual features may be included in different claims, but these may be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Reference signs in the claims are provided merely as a clarifying example and shall not be construed as limiting the scope of the claims in any way.

1-10. (canceled)

11. A method of allowing removal of measures provided on a portable storage medium (8) for disturbing the perception of content on the medium, the method comprising the steps of:
obtaining an identifier (DID) of the medium, (step 40),
obtaining an identifier (PID) of a media player (10) arranged for playing media content provided on the medium, (step 42),
generating an intermediate encryption key (I_K) from at least the medium identifier and the media player identifier, (step 44), such that a request for removal of the disturbing measure can be made,
providing a content provider (36) with at least the intermediate encryption key (step 46),
receiving an unlocking key (U_K), which has been encrypted on the basis of at least the intermediate encryption key, (step 48), and
decrypting the unlocking key, using at least the intermediate encryption key, step 50), and removing the measures for disturbing the perception of content by using the decrypted unlocking key, (step 52).

12. A method according to claim 11, further comprising the step of sending a request for removal of the disturbing measure to a content provider, (step 46), the request comprising the intermediate encryption key.

13. A method according to claim 11, comprising generating the intermediate encryption key by performing a hash of at least the medium identifier and the media player identifier.

14. A method according to claim 11, wherein the portable storage medium comprises at least one transport stream (TS1, TS2) comprising a first media stream combined with other media streams as well as a second media stream also provided in a transport stream, and a computer program code for making the media player provide a command structure (L1, L2, L3) set to select and present the second media stream in relation to the first media stream based on a user selection of reproducing content provided in the first media stream, for disturbing the perception of content provided in the first media stream, and
further comprising the step of removing the setting of selecting and presenting the second stream from the command structure.

15. A method according to claim 11, wherein the portable storage medium comprises a first media stream that is combined with at least a second media stream in a transport stream (TS2), wherein said second media stream provides the measures for disturbing the perception of the first media stream through at least one user-selectable object (4) provided in it, with which object an automatically performed action is associated, and further comprising the step of:
removing the link between the action and the object.

16. A media player (10) for allowing removal of measures provided on a portable storage medium (8) for disturbing the perception of content on the portable storage medium and having an identifier (PID), the media player comprising:
a disturbing measure removal unit (34) arranged to:
obtain an identifier (DID) of the medium,
obtain the media player identifier (PID),
generate an intermediate encryption key (I_K) from at least the medium identifier and the media player identifier, such that a request for removal of the disturbing measure can be made,
provide a content provider (36) with at least the intermediate encryption key,
receive an unlocking key (U_K), which has been encrypted on the basis of at least the intermediate encryption key, and
decrypt the unlocking key, using at least the intermediate encryption key, and remove the measures for disturbing the perception of content by using the decrypted unlocking key, (step 52).

17. A portable storage medium (8) to be used in a media player (10), the medium having stored thereon:
media content (C1, C2) and measures (MO2) provided for disturbing the perception of said content,
a medium identifier (DID), and
a computer program code, which, when loaded in the media player, enables said media player to:
obtain the medium identifier,
obtain an identifier of the media player (PID),
generate an intermediate encryption key (I_K) from at least the medium identifier and the media player identifier, such that a request for removal of the disturbing measure can be made,
provide a content provider with at least the intermediate encryption key, and
decrypt a received unlocking key (U_K), using at least the intermediate encryption key, remove the measures for disturbing the perception of content by using the decrypted unlocking key, (step 52).
